(19) United States
(12) Patent Application Publication
(10) Pub. No.: US 2009/0079100 A1
(43) Pub. Date: Mar. 26, 2009

(54) Surface Scraping Method for Light Guide Plate

(76) Inventors: HAN-JUNG CHEN, Hsinchu Industrial Park (TW); Jen-Rui Liu, Hsinchu Industrial Park (TW)

Correspondence Address: HDLS Patent & Trademark Services, P.O. BOX 220746, CHANTILLY, VA, 20153-0746, US

(21) Appl. No.: 12/136,126

(22) Filed: Jun. 10, 2008

(30) Foreign Application Priority Data
Sep. 20, 2007 (TW) 096135182

(51) Int. Cl. B29D 11/00

(52) U.S. Cl. 264/1.24

(57) ABSTRACT

A surface scraping method for a light guide plate includes the steps of providing a light guide plate, providing a scraper having an oscillating element which the scraper generates an oscillating variation by the oscillating element, and performing the scraper to scrape a surface of the light guide plate. Such that, a plurality of stripes are formed on the surface and a shape of each of the stripes is corresponding to the oscillating variation.

### BACKGROUND

1. Technical Field

The present invention generally relates to a surface scraping method for a light guide plate, particularly to a surface scraping method for a light guide plate surface by scraping the surface of the light guide plate to achieve better quality of bright-dark lines.

2. Description of the Related Art

A liquid crystal panel of a liquid crystal display (LCD) device is not capable of emitting light beams, therefore it needs a plate light source device such as a backlight module to provide sufficient and uniform luminance to the liquid crystal display panel and thus the liquid crystal display panel is capable of displaying images.

A conventional backlight module includes a light source, a reflection plate, a light guide plate, a diffusing plate and a prism plate, and the light guide plate is a vital element of the backlight module which is capable of scattering and reflecting light beams emitted from the light source and converting the light beams into a plate light source provided to the liquid crystal display panel.

A conventional light guide plate includes an incident surface, an emitting surface adjacent to the incident surface and a bottom surface opposite to the emitting surface. Usually, V-shape grooves are arranged on the emitting surface or\and the bottom surface of the light guide plate proportionally, which is capable of scattering and reflecting light beams emitted from a light source and converting the light beams into a plate light source. However, when the V-shape grooves structure makes light beams emitted from the light source into the light guide plate through the incident surface, a plurality of bright-dark lines with variable intervals appear on part of the emitting surface adjacent to the incident surface, which depresses the quality of display images, especially to a backlight module with lamp light source (such as Cold Cathode Fluorescent Lamps, CCFL), as shown in FIG. 5. Referring to FIG. 6, which shows light emitting diodes (LEDs) are used as the light source, there would be bright-dark areas on the emitting surface of the light guide plate.

Currently, the most common resolution according to the described problems is surface scraping on the incident surface of the light guide plate. It brings into effect by scraping the incident surface of the light guide plate by a scraper as shown in FIG. 7. The scraper 20 mostly is a poly-crystal diamond scraper and scrapes the incident surface of the light guide plate 10 along a latitudinal oscillation (as shown for Arrow A) reduplicative to adjust receivable bright-dark lines for the display quality.

However, although the surface scraping process is a standard process of the light guide plate manufacturing process, it is a very hard process. It needs an operator with training for years. In the current process, due to a reciprocating latitudinal oscillation of the scraper, a plurality of latitudinal oscillation tiny stripes are formed. But actually in a normal and good manufacturing environment, in theory, it is impossible to form stripes with a longitudinal oscillation or a specific direction. In recent years, the LED light source has replaced parts of the conventional lamp light source (such as Cold Cathode Fluorescent Lamps, CCFL) gradually, because of the character of point light source according to LED light source, it needs to form longitudinal oscillation stripes on a surface of the light guide plate, which is capable of converting the light beams provided by the LED light source into a plate light source before entering the light guide plate, and thus a conventional latitudinal oscillation scraping process adapted to LED light source of the light guide plate needs to be improved greatly.

### BRIEF SUMMARY

The present invention is to provide a surface scraping method for a light guide plate which is capable of achieving good quality of bright-dark lines display.

According to an embodiment of the present invention, a surface scraping method for a light guide plate is provided. The surface scraping method includes the steps of: providing a light guide plate; providing a scraper having an oscillating element to have an oscillating variation; using the scraper to scrape a surface of the light guide plate for forming a plurality of stripes on the surface and each of the stripes is corresponding to the oscillating variation.

At least two-dimensional oscillating variation in the process of scraping the surface of the light guide plate by an scraper improves the surface scrape control, such as surfaces with various roughness or scrape degree, or more various directions grooves so as to get the light guide plates with prospective quality of bright-dark lines. The various directions oscillations can increase the surface scraping force of the light guide plate, also improve the machining efficiency and save process time.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view according to a surface scraping method for a light guide plate showing a latitudinal oscillation, a longitudinal oscillation and an active oscillation.

FIG. 2 is a schematic view showing an oscillating variation along the active oscillation according to an embodiment of present invention.

FIG. 3 is a schematic view showing an oscillating variation along the latitudinal oscillation according to an embodiment of present invention.

FIG. 4 is a schematic view showing an oscillating variation along the longitudinal oscillation according to an embodiment of present invention.

FIG. 5 is a schematic view showing bright-dark lines on an emitting surface of a conventional light guide plate.

FIG. 6 is a schematic view showing bright-dark areas on an emitting surface of the conventional light guide plate.

FIG. 7 is a schematic view of a conventional surface scraping method for the light guide plate.

### DETAILED DESCRIPTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

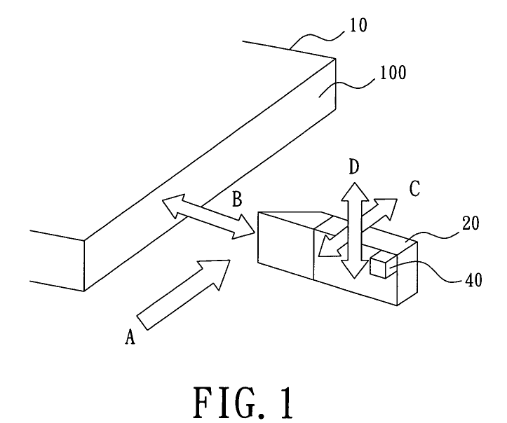

Referring to FIG. 1, an embodiment according to the present invention provides a surface scraping method for a light guide plate, which includes following steps:

S1: providing a light guide plate 10;

S2: providing a scraper 20 with an oscillating element 40, the oscillating element 40 driving the scraper 20 to generate an oscillating variation on an surface 100 of the light guide plate 10; and

S3: performing the scraper 20 to the surface 100 of the light guide plate 10 and scraping the surface 100, thus a plurality of stripes are formed on the surface 100 and a shape of each of the stripes is corresponding to the oscillating variation.

In step S1, the material of the light guide plate 10 is transparent material, such as polymthyl metharylate (PMMA) or polycarbonate (PC).

In step S2, the oscillating element 40 arranged on the scraper 20 is capable of controlling the scraper 20 to form tiny oscillations with different directions, and this forms more various grooves or stripes. The oscillating element 40 may be an electromagnetic oscillation element, a piezoelectric element or an ultrasonic oscillator.

In step S3, the scraper 20 with the oscillating element 40 generates a three-dimensional oscillating variation on the surface 100 of the light guide plate 10, that is an oscillation including a latitudinal oscillation, a longitudinal oscillation and an active oscillation. The latitudinal oscillation is a reciprocating oscillation with a direction parallel to an extended direction of the surface 100 of the light guide plate 10, as shown for Arrow C. The longitudinal oscillation is a reciprocating oscillation with a direction vertical to an extended direction of the surface 100 of the light guide plate 10, as shown for Arrow D. Moreover, the active oscillation is a reciprocating oscillation with a direction parallel to a normal direction of the surface 100 of the light guide plate 10, as shown for Arrow B. In this embodiment, the surface 100 refers to the incident surface of the light guide plate 10, also to other surfaces of the light guide plate 10.

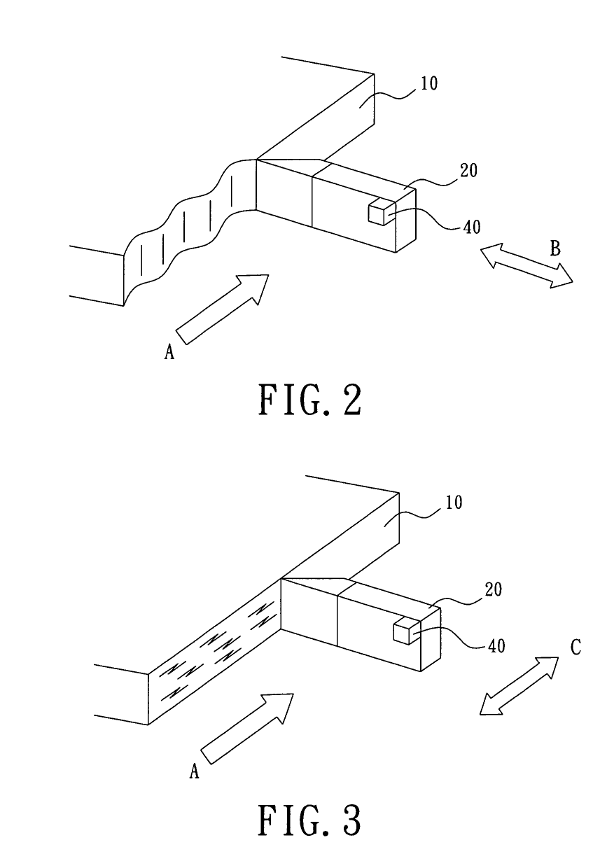

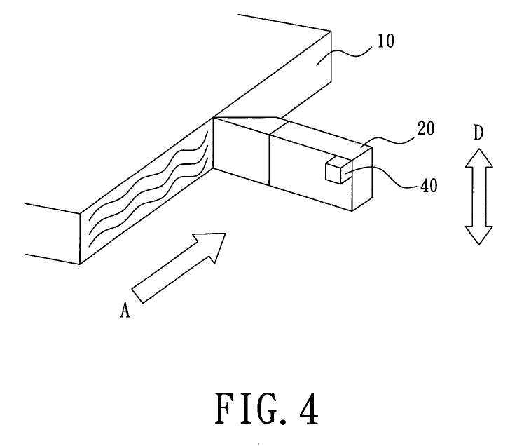

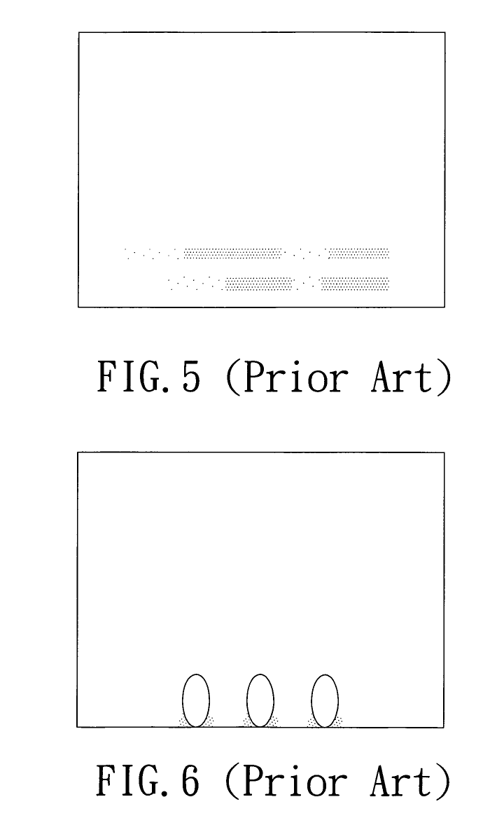

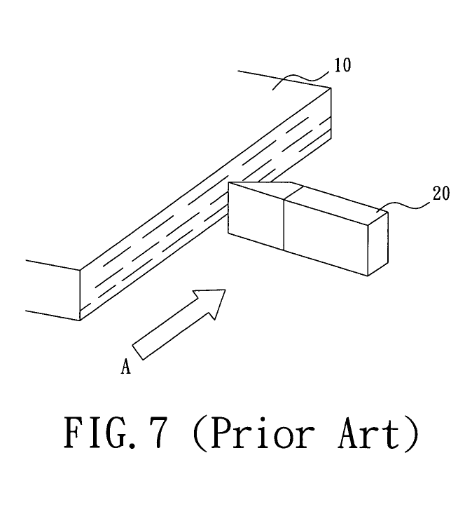

More detailed description is, referring to FIG. 2, when the scraper 20 oscillates along the active oscillation direction (as shown for Arrow B), because of moving along a direction parallel to the extended direction of the surface 100 of the light guide plate 10 (as shown for Arrow A) at the same time, thus parts of the stripes on the surface 100 of the light guide plate 10 formed by the scraper 20 are vertical to the surface 100 of the light guide plate 10. Also as shown in FIG. 3, when the scraper 20 moves along an extended direction of the surface 100 of the light guide plate 10 (as shown for Arrow A), the oscillating element 40 makes the scraper 20 oscillating along the latitudinal oscillation (as shown for Arrow C), and also because a speed of the scraper 20 changes fluctuant to reciprocate, parts of the stripes on the surface 100 of the light guide plate 10 are parallel to an extended direction of the surface 100 of the light guide plate 10. More in details, a plurality of fitful latitudinal stripes are formed on the surface 100 of the light guide plate 10 by the scraper 20 to make the roughness or scrape degree of the surface 100 changing variously. Moreover, referring to FIG. 4, according to the scrape theory, when the scraper 20 moves along an extended direction of the surface 100 of the light guide plate 10 (as shown for Arrow A), the oscillating element 40 makes the scraper 20 oscillating along the longitudinal oscillation (as shown for Arrow D), parts of the stripes on the surface 100 of the light guide plate 10 formed by the scraper 20 are fluctuant. Usually, the described oscillating element 40 makes the scraper 20 to generate an active oscillation, a latitudinal oscillation and a longitudinal oscillation, which is capable of generating fitful and non-repetitious stripes and grooves when the scraper 20 moves along an extended direction of the surface 100 of the light guide plate 10.

Due to an oscillating element 40 driving the scraper 20 to scrape the surface 100 of the light guide plate 10 to generate a three-dimensional oscillating variation, which is capable of generating fitful and non-repetitious stripes and grooves, especially the longitudinal grooves to be adapted for a backlight module with Light Emitting Diode (LED) and light guide plate 10, this avoids bright-dark lights in a conventional light source display. The three-dimensional oscillating variation by the scraper 20 is capable of improving the surface scrape control, such as surfaces with various roughness or scrape degree, or more various directions grooves so as to get the light guide plates with prospective quality of bright-dark lines. The various directions oscillations increase the surface scraping force of the light guide plate, also improve the machining efficiency and save process time.

The surface scraping method for the light guide plate according to the invention may be variant, such as the oscillating element 40, not limited by any configuration or theory, may be an electromagnetic oscillation element, a piezoelectric element or an ultrasonic oscillator as long as to generate oscillation. The oscillating element 40 works with an electronic system (not shown) to control oscillation frequency and amplitude. Commonly, an ultrasonic oscillator may control the oscillation with over a frequency of 20 KHz and scrape the surface 100 of the light guide plate 10 without noise. Furthermore, because a speed of the electronic system is much higher than that of mechanism, a scrape degree of the surface 100 of the light guide plate 10 may be changeable on demand, such as, part surface adjacent to the edges may be scraped more than that in central area to improve the performance of dark corner. The oscillation directions of the scraper 20 are not limited by the described latitudinal oscillation, longitudinal oscillation and active oscillation, also may be more than two or three directions oscillations as needed in order to optimize the surface scraping.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A surface scraping method for a light guide plate, comprising following steps:
providing a light guide plate;
providing a scraper having an oscillating element, wherein the scraper generates an oscillating variation by the oscillating element; and
performing the scraper to scrape a surface of the light guide plate for forming a plurality of stripes on the surface, wherein a shape of each of the stripes is corresponding to the oscillating variation.

2. The surface scraping method according to claim 1, wherein the oscillating variation of the scraper comprises a latitudinal oscillation, a longitudinal oscillation or an active oscillation or a combination thereof.

3. The surface scraping method according to claim 2, wherein a direction of the latitudinal oscillation is parallel to an extended direction of the surface of the light guide plate, a direction of the longitudinal oscillation is vertical to the extended direction of the surface of the light guide plate, and a direction of the active oscillation is parallel to a normal direction of the surface of the light guide plate.

4. The surface scraping method according to claim 3, wherein when the scraper oscillates along the active oscillation, parts of the stripes on the surface formed by the active oscillation are vertical to the surface of the light guide plate.

5. The surface scraping method according to claim 3, wherein when the scraper oscillates along the latitudinal oscillation, parts of the stripes on the surface formed by the latitudinal oscillation are parallel to an extended direction of the surface of the light guide plate.

6. The surface scraping method according to claim 3, wherein the when the scraper oscillates along the longitudinal oscillation, parts of the stripes on the surface formed by the longitudinal oscillation are fluctuant.

7. The surface scraping method according to claim 1, wherein the oscillating element comprises an electromagnetic oscillation element, a piezoelectric element or an ultrasonic oscillator.

8. The surface scraping method according to claim 1, wherein the oscillating element is controlled by an electronic system to provide oscillation frequency and amplitude.

9. The surface scraping method according to claim 1, wherein the surface is an incident surface of the light guide plate.

10. The surface scraping method according to claim 1, wherein the light guide plate is transparent.

11. The surface scraping method according to claim 10, wherein material of the light guide plate comprises polymthyl metharylate or polycarbonate.
